(19) United States
(12) Patent Application Publication
(10) Pub. No.: US 2009/0091417 A1
(43) Pub. Date: Apr. 9, 2009

(54) Thermal fuse employing thermosensitive pellet

(75) Inventor: Tokihiro Yoshikawa, Koka-shi (JP)

Correspondence Address: FASSE PATENT ATTORNEYS, P.A., P.O. BOX 726, HAMPDEN, ME, 04444-0726, US

(73) Assignee: NEC SCHOTT Components Corporation, Koka-shi (JP)

(21) Appl. No.: 12/284,936

(22) Filed: Sep. 23, 2008

(30) Foreign Application Priority Data
Oct. 5, 2007 (JP) 2007-261558 (P)

(51) Int. Cl. H01H 37/00

(52) U.S. Cl. 337/298

(57) ABSTRACT

A thermal fuse employing a thermosensitive pellet is provided which uses a new substance exhibiting stabilized characteristics as a thermosensitive material used in the case where the thermal fuse employing a thermosensitive pellet has an operating temperature in a low temperature region. The thermal fuse employing a thermosensitive pellet of the present invention includes at least a switching movable member, a thermosensitive pellet member, a pair of leads having a first lead portion and a second lead portion, and a metal casing, in which the thermosensitive pellet member contains a polyolefin wax, the thermosensitive pellet member is housed in the metal casing to which the pair of leads are attached, the switching movable member is operated by deformation associated with softening or melting of the thermosensitive pellet member, to attain a cut-off state between the pair of leads, and the thermal fuse employing a thermosensitive pellet is suitable for an operating temperature of 50 to 180° C. Furthermore, the thermosensitive pellet member is used mixed with a thermoplastic resin as appropriate, to thereby provide a thermal fuse employing a thermosensitive pellet which increases the response speed while maintaining the operating temperature with high accuracy.

### BACKGROUND OF THE INVENTION

1. Field of the Invention

The present invention relates to a thermal fuse selecting and using, as a thermosensitive material, a polyolefin wax typified by polyethylene and polypropylene, each of which are a thermoplastic wax.

2. Description of the Background Art

The thermal fuse employing a thermosensitive pellet using a non-conductive thermosensitive material (hereinafter simply referred to as a thermosensitive material) is a so-called irreversible type thermal switch which generally operates at a prescribed temperature at which the thermosensitive material formed into a pellet shape is softened and melted, to interrupt the current conducting path of equipment and an apparatus for protection thereof. It operates at a temperature (operating temperature) approximately determined by the composition of the thermosensitive material to be used, in which the operating temperature is set by selecting and adjusting a switching component such as a spring. For example, the thermal fuse employing a thermosensitive pellet is configured such that the non-conductive thermosensitive material is pelletized and used in a metal casing having a lead attached at each end, in which a switching member including a spring member such as a compression spring and a slidable contacting conductor is disposed and housed in the predetermined position of the metal casing. The thermosensitive material to be pelletized includes, in addition to a pure chemical substance alone, a thermoplastic resin material used alone or as a composite. In this case, the thermosensitive pellet softens or melts at a prescribed operating temperature and the pressure effect of the compression spring moves the contact of the movable conductor to thereby cause interruption between a pair of leads. As a thermosensitive material of the thermosensitive pellet that is pelletized by the prescribed forming process including granulation and tableting, a thermoplastic resin material is recently used which is characteristically advantageous because of an improvement concerning the adjustment of the operating temperature.

Japanese Patent Laying-Open Nos. 2003-317589, 2005-158681 and 2006-260926 (Patent Documents 1 to 3) disclose improved structures according to the proposal by the inventor of the present invention as a thermal fuse employing a thermosensitive pellet using a non-conductive thermoplastic resin material for a thermosensitive material. These provide a method for solving some problems concerning the excellent workability and operating characteristics in the case where the thermoplastic resin is used as a thermosensitive material, and, for example, present selection of the resin material, means for adjusting the operating temperature, and appropriate countermeasures against the characteristic degradation associated with the change over time.

### SUMMARY OF THE INVENTION

A thermal fuse employing a thermosensitive pellet is configured such that a non-conductive thermosensitive pellet is housed together with a compression spring and a movable conductor in a metal casing having a lead attached at each end, in which the thermosensitive pellet softens or melts at a prescribed operating temperature and the pressure effect of the compression spring causes the contact of the movable conductor to be moved. However, the above-described thermal fuse employing a thermosensitive pellet using a thermoplastic resin for the thermosensitive pellet produces problems such as that the setting of the operating temperature in a relatively low temperature region is difficult and the actuation at the prescribed operating temperature requires a long period of time. It is conceivable to use, as a thermosensitive material in the low temperature region, a wax such as an animal-based shellac wax, a plant-based carnauba wax or a mineral-based paraffin wax, each of which are a natural wax. However, these natural waxes each have a complicated melting peak and a wide range of the melting temperature, which leads to a shortcoming including the instability of the operating temperature. Furthermore, these natural waxes are difficult to be released from the mold in the pelletization process and are sticky when contacting a human hand during the operation, which causes handling problems.

An object of the present invention is, therefore, to provide a thermal fuse employing a thermosensitive pellet that uses a synthetic wax obtained by chemical synthesis instead of a naturally-derived wax. The synthetic wax is, as a thermoplastic wax, distinguished from a thermoplastic resin. In the present invention, the synthetic wax means that having a weight average molecular weight of 100,000 (Mw) or less measured by a gel permeation chromatography (GPC) method. The synthetic wax serves to solve the above-described problems and allows quick actuation and operation, and the thermosensitive material exhibits excellent characteristics for balance of retentivity, hardness and toughness in terms of the mechanical physical properties, workability, and handleability. It is to be noted that the weight average molecular weight measured by the above-mentioned GPC method is a polystyrene reduced value and corresponds to that same value in the present invention unless otherwise stated.

Another object of the present invention is to obtain a thermosensitive pellet member having high operation performance by selecting a polyolefin wax which is a thermoplastic wax for a thermosensitive substance, and mixing or adding a supplementary agent such as a thermoplastic resin, an antioxidant, a plasticizer and a filler as required. In this case, a thermal fuse employing a thermosensitive pellet is provided in which the weight average molecular weight of the wax is regulated based on the hardness to set an operating temperature. It is to be noted that the thermoplastic resin is used mixed with the same type of the polyolefin resin to allow facilitation of fine adjustment of the operating temperature and pelletization. For example, a thermal fuse employing a thermosensitive pellet can be provided which is resistant to variation in characteristics and allows the time for stabilization and actuation to be shortened while allowing pelletization by the method such as the conventional injection molding and extrusion.

According to the present invention, a thermal fuse employing a thermosensitive pellet is provided in which a switching movable member and a thermosensitive pellet member containing a polyolefin wax are housed in a cylindrical casing to which a pair of leads are attached, and the switching movable member is operated by the deformation associated with softening or melting of the thermosensitive pellet member to attain a cut-off state between the leads. An antioxidant and the like are added to the above-described thermosensitive pellet member in which the operating temperature is set within a range of 50 to 180° C. and preferably 50 to 90° C. Furthermore, the polyolefin wax is selected from one type or two or more types of polyethylene, polypropylene or poly-α-olefin.

In another aspect of the present invention, in the thermal fuse employing a thermosensitive pellet in which the thermosensitive pellet member containing a polyolefin wax as a main component is used to set the operating temperature within a range of 50 to 180° C., a crystalline higher α-olefin polymer and a hydrocarbon wax composition are preferable. Furthermore, it is disclosed that the polyolefin wax is produced using a metallocene catalyst, has a weight average molecular weight within a range of 1,000 to 100,000 (Mw) measured by a gel permeation chromatography (GPC) method, and specifically has a hardness with a rate of penetration in accordance with a measuring method defined in JIS K 2207 being not more than 10. Thus, the thermal fuse employing a thermosensitive pellet allowing the operating temperature to be set within a range of 50 to 180° C. and having an operating temperature in a low temperature region is provided, with the result that a new usage may be developed and its practical effect may be highly evaluated. Furthermore, the polyolefin resin is mixed with the polyolefin wax to thereby allow the molding ability by the wax to be inhibited or improved in the case where the injection molding or the extrusion is applied as a pellet molding method. In this case, it is desirable to select the resin to be mixed from the materials each having a melting point closer to that of the polyolefin wax. Mixing of such a resin allows fine adjustment of the operating temperature.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a partial cross-sectional view of a thermal fuse employing a thermosensitive pellet of an example according to the present invention in a normal state at normal temperature.

FIG. 2 is a partial cross-sectional view of the thermal fuse employing a thermosensitive pellet of the example according to the present invention after the rise to the abnormal temperature.

### DESCRIPTION OF THE PREFERRED EMBODIMENTS

An embodiment of the present invention provides a thermal fuse employing a thermosensitive pellet including a metal casing; a pair of lead members having a first lead portion caulked at one end of this metal casing and a second lead portion fixed at the other end of the casing via an insulation bushing; and a switching member housed in the metal casing and having a spring member, a movable conductor and a thermosensitive pellet, in which, in an irreversible type thermal fuse cutting off an electrical circuit between the pair of lead members at a prescribed operating temperature by the softening and melting of the thermosensitive material of the thermosensitive pellet, a polyolefin wax is used as a main component for the thermosensitive material, particularly, the wax having a melting point closer to the desired operating temperature is selected to set the operating temperature within a desired range of 50 to 180° C., and thermal deformation of the thermosensitive pellet causes the switching member to be operated for interruption of the circuit. Conventionally, the thermosensitive material for a low temperature region using a paraffin wax as a main component has disadvantages including broad melting temperature characteristics and a difficulty in handling, and accordingly, a practical use thereof becomes difficult in the region having a temperature below approximately 90° C. In this regard, the thermosensitive material of the present invention is used to thereby allow for quick actuation, high accuracy and high reliability even in the case of the thermal fuse employing a thermosensitive pellet having an operating temperature of 50 to 90° C.

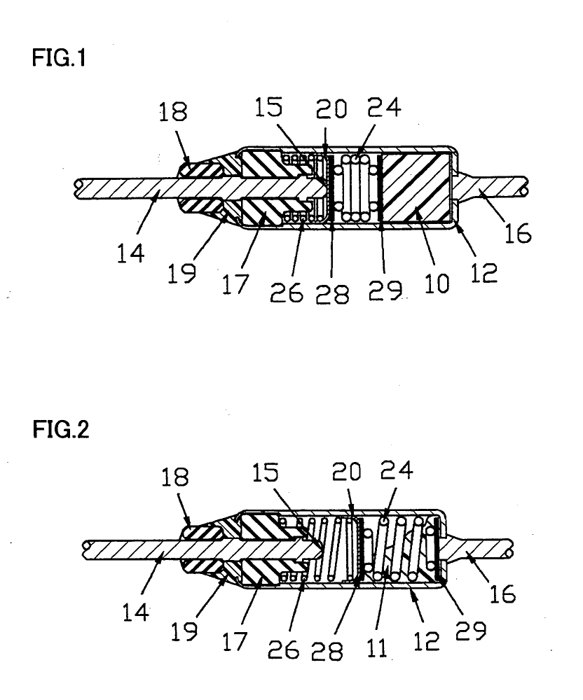

Specifically, as shown in FIG. 1, attached to a metal casing 12 is a pair of lead members having a first lead portion 14 fixed at one opening of metal casing 12 and a second lead portion 16 caulked at the other opening of metal casing 12, and this metal casing 12 houses therein a thermosensitive pellet member 10, a movable conductor 20, and a switching function member (switching movable member) including a spring member having a strong compression spring 24 and a weak compression spring 26, to thereby configure a thermal fuse employing a thermosensitive pellet. The thermal fuse employing a thermosensitive pellet is provided in which thermosensitive pellet member 10 includes a polyolefin wax as a main component of the thermosensitive material and an operating temperature is set with a melting point of 50 to 180° C. and specifically of 90 to 152° C. in examples:

The composition constituting the thermosensitive pellet member is used with a polyolefin wax mixed with other thermoplastic resin material, preferably the same type of resin as the wax, and added with an additive such as a plasticizer, a rubber material, a filler and an antioxidant, to thereby adjust the operating temperature. Furthermore, while the polyolefin wax is produced by a method which varies depending on whether a Ziegler catalyst or a metallocene catalyst is used, it has been found that the polyolefin wax of the metallocene catalyst is preferable to that of the Ziegler catalyst. It is to be noted that metallocene means a polymer polymerized using the metallocene catalyst (for example, linear low density polyethylene (LLDPE) and polypropylene produced using the metallocene catalyst). The polymer polymerized using the metallocene catalyst is uniform in molecular weight distribution and crystallinity. The polymer also has characteristics that less low molecular weight component leads to less stickiness and that the range of the melting temperature is narrow. It specifically corresponds to polyethylene having a melting point of 100 to 140° C. and polypropylene having a melting point of 120 to 175° C. Polypropylene here also includes a random copolymer having a low melting point. Furthermore, it has been found that it is preferable to use, for a polyolefin wax, one type or two or more types of polymers selected from a group consisting of polyethylene, polypropylene and poly-α-olefin. In the case where the above-described polymers are used, the mixing ratio thereof is not particularly limited and the composition including a weight average molecular weight and a hardness described below is preferable.

It is desirable that the polyolefin wax has a weight average molecular weight measured by a gel permeation chromatography (GPC) method falling within a range of 1,000 to 100,000 (Mw). Specifically, the weight average molecular weight corresponds to a value measured by the GPC method using, as a measuring apparatus, Alliance GPC2000 manufactured by Waters Corporation; at an elution temperature of 140° C.; as a column to be used, Styragel GPC Column (4.6 mm×300 mm) (HT-3, HT-4 and HT-6E in series) manufactured by Waters Corporation; and polystyrene as a molecular weight standard substance sample (manufactured by Shodex Co., molecular weight of 5030, 55100, 696000, 3740000, 1990, 13900, 197000, 2210000). The present invention also provides a thermal fuse employing a thermosensitive pellet made of such a polyolefin- wax having a hardness with a rate of penetration in accordance with the measuring method defined in JIS K 2207 being not more than 10. The outline of the testing method for the rate of penetration defined in JIS is such that a sample is heated, melted and placed in a sample container to be cooled, and kept at a constant temperature in an isothermal water bath, then causing a specified needle having a total mass of 100 g to be vertically introduced into the sample for 5 seconds. The rate of penetration of the needle is represented by a value (absolute number) obtained by measuring the penetration depth of the needle in units of 0.1 mm and multiplying the result by 10.

The feature of the present invention lies in finding remarkable distinctive advantages that the polyolefin wax as a thermosensitive material is stabilized at the operating temperature in the low temperature region and quickly actuated, and the like. Even if the thermosensitive pellet member is a conventional member using a crystalline thermoplastic resin as a thermosensitive material, the resin materials vary widely, and in order to select a specific substance therefrom, it is necessary to recognize the characteristics of each material and take the industrial applicability as a thermosensitive pellet into consideration. While the selection is made after much trial and error, the present invention is particularly remarkable as a thermosensitive material in the low temperature region. The operating temperature of the thermal fuse employing a thermosensitive pellet can be finely adjusted by the pressing force of the spring of the spring member of the switching movable member. Accordingly, if the melting point of the thermosensitive material to be used is selected, an operating temperature can be readily set. For example, in the case of the polyolefin wax, as arbitrarily determined by the melting point, the extrapolated initial melting temperature (Tim) and the extrapolated ending melting temperature (Tem), it is experimentally revealed whether it is appropriate or not as a thermosensitive material for a thermal fuse in the present invention, in consideration of the actuation speed and the mechanical physical properties of the selected polyolefin wax.

The prescribed operating temperature is set by selecting the thermal deformation temperature, can be adjusted within the range of the melting point of the polyolefin wax, that is, within the range of the above-described Tim and Tem,.and can be achieved by arbitrarily changing the weight average molecular weight as means for adjusting the thermal deformation temperature. According to the present invention, it has been found that the weight average molecular weight can be selected preferably from the range of 1,000 to 100,000 (Mw) thereof, and, more preferably, from the range of 1,000 to 50,000 (Mw) thereof. Furthermore, the thermal deformation temperature can be raised or lowered by adding a plasticizer or a filler to the polyolefin wax. In addition, the supplementary agent includes secondary materials for resin classified into three types including an additive, a reinforcement material and a filler. The additive generally includes an antioxidant, a thermostabilizer, a photostabilizer, a crystal nucleating agent a compatibilizer, a colorant, an antimicrobial agent, an antifungal agent, lubricant, and a foaming agent. The remarkable additives among them include the antioxidant, the thermostabilizer, the crystal nucleating agent by which the degree of crystallinity is increased, and the colorant by which the temperature range is identified. The reinforcement material includes mica, calcium carbonate, glass fiber, rubber material, carbon fiber, aramid fiber and the like, which are added when the thermosensitive pellet in a copolymer or an elastomer softens more than necessary or the physical dimensional stability of the thermosensitive pellet requires to be maintained at high temperature. The filler includes an extender such as talc, clay, and calcium carbonate. The extender is introduced into the resin to minimize the cost for the raw material(s) of the resin. Furthermore, there are also a flame retarder helping the resin to be less flammable, and an antistatic agent introduced to prevent the resin from storing electricity. Furthermore, the operating temperature can be finely adjusted by adjusting the spring of the switching movable member. The antioxidant can include a phenol type, a phosphorus type, a sulfur type and the like by way of example. The antioxidant in the present invention can also include a heat-resistant stabilizer such as a lactone type, a hydroxylamine type, vitamin E, and a metal deactivator. Particularly, when the phenol type and the sulfur type are added as an antioxidant, the performance of the thermal fuse employing a thermosensitive pellet containing an olefin wax can be improved.

### EXAMPLES

Although the present invention will be hereafter described in greater detail in connection with examples, the present invention is not limited thereto.

In the present examples, a thermal fuse employing a thermosensitive pellet having the structure shown in FIG. 1 was manufactured.

FIGS. 1 and 2 each show a thermal fuse employing a thermosensitive pellet of the examples according to the present invention. FIG. 1 is a partial cross-sectional view of the thermal fuse employing a thermosensitive pellet in a normal state at normal temperature, and FIG. 2 is a partial cross-sectional view of the thermal fuse employing a thermosensitive pellet after the rise to the abnormal temperature. As shown in FIG. 1, the thermal fuse employing a thermosensitive pellet according to the present invention is configured such that a thermosensitive pellet member 10 and a switching function member described below are housed in a cylindrical metal casing 12. Metal casing 12 has a pair of lead members attached thereto, in which metal casing 12 has a first lead portion 14 fixed at one opening and a second lead portion 16 caulked at the other opening. First lead portion 14 extends into metal casing 12 through an insulation bushing 17 by which it is insulated from metal casing 12, and has a tip portion 15 formed as a first electrode. First lead portion 14 has an externally guided portion provided with an insulation tube 18 for protection which is fixedly sealed by a sealing resin 19 sealing the opening of metal casing 12. On the other hand, second lead portion 16 is fixed in contact with metal casing 12 directly by caulking, and an inner surface of metal casing 12 itself is formed as a second electrode. The switching function member housed in metal casing 12 includes the above-described thermosensitive pellet member 10, a movable conductor 20 having a central contact and a star-shaped peripheral contact, and a spring member having a strong compression spring 24 and a weak compression spring 26. In the spring member of the strong and weak compression springs at normal temperature, as shown in FIG. 1, strong compression spring 24 acting against the resilience of weak compression spring 26 presses and thus bring movable conductor 20 into contact with the first electrode. In particular, strong compression spring 24 is disposed between thermosensitive pellet member 10 and movable conductor 20 with pressure plates 28 and 29 interposed therebetween to facilitate assembly and also allow the stabilized spring operation. In abnormal condition associated with increased temperature, as shown in FIG. 2, the softened or melted thermosensitive pellet member (thermosensitive pellet member 11 after melting) deforms, causing weak compression spring 26 to exert force to press and thus move movable conductor 20. Strong compression spring 24 has a spring released from its stroke range, and weak compression spring 26 exerts force to push movable conductor 20 within its stroke range, causing movable conductor 20 to slide on the second electrode located at the inner surface of metal casing 12. Movable conductor 20 is thus moved to disconnect movable conductor 20 itself from tip portion 15 of the first electrode, which, in turn, switches off an electrical circuit. Note that the thermal fuse employing a thermosensitive pellet shown in FIGS. 1 and 2 configures an irreversible-type thermal fuse employing a thermosensitive pellet normally turned on and turned off for abnormality.

The thermal fuse employing a thermosensitive pellet of the present invention is configured such that a metallic cylindrical casing (metal casing) having a pair of leads attached thereto houses a switching movable member including a movable conductor and a thermosensitive pellet member containing a polyolefin wax as a main component, in which the deformation associated with the softening and melting of the thermosensitive pellet member causes the movable conductor to slide, to thereby attain a cut-off state between the leads within a range of 50 to 180° C. of the prescribed operating temperature. In this case, the thermosensitive pellet member is a synthetic wax chemically synthesized and having a weight average molecular weight of 1,000 to 100,000 (Mw) measured by the gel permeation chromatography (GPC) method. Preferably, the well-known crystalline higher α-olefin polymer or the wax composition containing the same and a hydrocarbon wax can be used, which allows for the thermal fuse employing a thermosensitive pellet having an excellent balance of retentivity, hardness, toughness and the like and presenting improved mechanical physical properties. Note that it is also possible to provide a thermal fuse employing a thermosensitive pellet in which the thermosensitive pellet containing a polyolefin wax as a main component can be used mixed with a different thermoplastic resin and thermoplastic wax, to which an antioxidant and the like are added. In the examples, prototype example products 1-6 using six types of polyolefin waxes were compared with comparative products 1 and 2 using the conventional paraffin wax and polyethylene resin for review. In other words, the thermosensitive pellets were prepared for each product, which were then used to prepare the thermal fuse for comparison and review.

TABLE 1

| | | Weight | | Hardness |
|---|---|---|---|---|
| | | Average | Melting | (Rate of |
| | | Molecular | Point | Penetra- |
| | Composition | Weight | (° C.) | tion) |
| Example | Polyethylene Wax | 2,000 | 122 | 1 |
| Product 1 | (Ziegler-Natta Catalyst) | | | |
| Example | Polyethylene Wax | 1,000 | 109 | 25 |
| Product 2 | (Ziegler-Natta Catalyst) | | | |
| Example | Polyethylene Wax | 3,000 | 109 | 10 |
| Product 3 | (Ziegler-Natta Catalyst) | | | |
| Example | Polyethylene Wax | 2,000 | 124 | 1 |
| Product 4 | (Metallocene Catalyst) | | | |
| Example | Polyethylene Wax | 4,600 | 90 | 2 |
| Product 5 | (Metallocene Catalyst) | | | |
| Example | Polypropylene Wax | 30,000 | 152 | not more |
| Product 6 | (Ziegler-Natta Catalyst) | | | than 1 |
| Comparative | Paraffin Wax | 500 | 76 | 23 |
| Product 1 | | | | |
| Comparative | Polyethylene Resin | 140,000 | 117 | — |
| Product 2 | (Metallocene Catalyst) | | | |

Table 1 shows the names of the thermosensitive materials and the values of their physical characteristics concerning six types of different polyolefin waxes targeted for review as an example product of the present invention, and a conventional paraffin wax and polyethylene resin, each of which are a comparative product. It is to be noted that substances made of a Ziegler catalyst and a metallocene catalyst by different manufacturing methods, respectively, each are used as a polyolefin wax and the used catalysts each are listed in brackets in the column of the main composition in Table 1.

TABLE 2

| | | | | | | | Standard |
|---|---|---|---|---|---|---|---|
| | Operating Temperature (° C.) | | | | | ΔT (° C.) | Deviation |
| Example | 120.3 | 121.1 | 120.8 | 120.9 | 121.8 | 1.5 | 0.5 |
| Product 1 | | | | | | | |
| Example | 107.3 | 108.3 | 108.0 | 107.7 | 107.2 | 1.1 | 0.5 |
| Product 2 | | | | | | | |
| Example | 107.9 | 108.7 | 108.5 | 108.4 | 108.2 | 0.8 | 0.3 |
| Product 3 | | | | | | | |
| Example | 123.8 | 123.7 | 123.9 | 123.6 | 123.8 | 0.3 | 0.1 |
| Product 4 | | | | | | | |
| Example | 90.2 | 90.5 | 90.3 | 90.2 | 89.9 | 0.6 | 0.2 |
| Product 5 | | | | | | | |
| Example | 150.3 | 150.2 | 150.8 | 150.9 | 151.2 | 1.0 | 0.4 |
| Product 6 | | | | | | | |
| Comparative | 74.3 | 70.6 | 68.9 | 71.2 | 64.2 | 10.1 | 3.7 |
| Product 1 | | | | | | | |
| Comparative | 117.7 | 117.6 | 117.5 | 117.8 | 117.9 | 0.4 | 0.2 |
| Product 2 | | | | | | | |

Table 2 shows five respective operating temperatures concerning the thermal fuses produced with the thermosensitive pellets of the example products made of the polyolefin waxes, respectively, shown in Table 1 and the thermal fuses produced using, for the thermosensitive pellets, the conventional products made of the paraffin wax and the polyethylene resin, respectively, each of which are a comparative product shown in Table 1. According to this table, ΔT is as high as 10.1° C. ΔT shows the difference between the highest operating temperature and the lowest operating temperature corresponding to the variations of the operating temperature of the paraffin wax of the comparative example. In comparison to this, it has been found that the polyolefin wax of the present invention shows ΔT of 2° C. or less in each example product, and thus, provides excellent accuracy in operation.

TABLE 3

| | Immersion | | | | | | |
|---|---|---|---|---|---|---|---|
| | Temperature | Time Required to Start Operation | | | | | Average |
| | (° C.) | (sec.) | | | | | (sec.) |
| Example | 144 | 12.2 | 11.9 | 11.8 | 13.3 | 12.2 | 12.3 |
| Product 1 | | | | | | | |
| Example | 129 | 10.6 | 10.9 | 8.9 | 9.3 | 9.7 | 9.9 |
| Product 2 | | | | | | | |
| Example | 129 | 12.3 | 12.5 | 11.1 | 11.3 | 11.8 | 11.8 |
| Product 3 | | | | | | | |
| Example | 144 | 12.0 | 11.8 | 11.6 | 11.9 | 13.2 | 12.1 |
| Product 4 | | | | | | | |
| Example | 110 | 13.3 | 13.2 | 13.8 | 14.1 | 13.5 | 13.6 |
| Product 5 | | | | | | | |
| Example | 172 | 15.5 | 15.2 | 16.3 | 16.2 | 16.8 | 16.0 |
| Product 6 | | | | | | | |
| Comparative | 96 | 8.6 | 9.3 | 9.2 | 9.5 | 9.7 | 9.3 |
| Product 1 | | | | | | | |
| Comparative | 137 | 20.8 | 19.7 | 20.8 | 20.9 | 20.6 | 20.6 |
| Product 2 | | | | | | | |

As in Table 2, Table 3 shows the measured values of each time required for the thermal fuse to start operating when immersed in an oil bath, with regard to prototypes of the thermal fuses produced using the polyolefin waxes, each of which are an example of the present invention and comparative products of the thermal fuses each produced using the conventional thermosensitive pellet member. In the case where each thermal fuse was immersed in the oil bath having a temperature 20° C. higher than the respective prescribed operating temperatures, the test conditions of the oil bath was obtained by measuring the time from the introduction to the start of the operation (the time required to start the operation, which is also referred to as a response time). As can be seen from the results in Table 3, it has been found that while each of example products 1 to 6 having the polyolefin wax of the present invention incorporated into the therrnosensitive pellet provides the response time inferior to the response speed in the case of the paraffin wax of a comparative product 1, the response time is significantly improved as compared to the case where the polyethylene resin having a molecular weight of 100,000 or more which is a comparative product 2 of a conventional art is used for the thermosensitive pellet member. In this case, the polyolefin wax as a thermosensitive pellet member is apparently different from the polyolefin resin as a material. Further preferably, the weight average molecular weight of the polyolefin wax is selected from within a range of 1,000 to 100,000 (Mw). The response time may be degraded in the case of the weight average molecular weight exceeding 100,000 (Mw), and thus, the upper limit is set to 100,000 (Mw).

TABLE 4

| | | Number of Disconnection | |
|---|---|---|---|
| | Storage | (Number of Disconnection/ | |
| | Temperature | Number of Tests) | |
| | (° C.) | After 3000 Hours | After 5000 Hours |
| Example | 112 | 0/10 | 0/10 |
| Product 1 | | | |
| Example | 99 | 2/10 | 10/10 |
| Product 2 | | | |
| Example | 99 | 0/10 | 1/10 |
| Product 3 | | | |
| Example | 114 | 0/10 | 0/10 |
| Product 4 | | | |
| Example | 80 | 0/10 | 0/10 |
| Product 5 | | | |
| Example | 142 | 0/10 | 0/10 |
| Product 6 | | | |
| Comparative | 66 | 10/10 | 10/10 |
| Product 1 | | | |
| Comparative | 107 | 0/10 | 0/10 |
| Product 2 | | | |

Table 4 shows the result of checking for disconnection after each thermal fuse employing a thermosensitive pellet prepared using the material listed in Table 1 was stored for 3000 hours and 5000 hours at the temperature 10° C. lower than the melting point of the thermosensitive pellet member. The number of tests to be carried out is assumed to be 10. As a result of the tests, after 3000 hours, all of the ten paraffin waxes were disconnected in a comparative product 1 and two of ten were disconnected in an example product 2 having a hardness of 25. Similarly, after 5000 hours, all of ten were disconnected in example product 2 having a hardness of 25 and one of ten was disconnected in an example product 3 having a hardness of 10. It has thus been found that, with regard to the characteristics required for the thermosensitive pellet member for the thermal fuse requiring the conditions of use at high temperature, a practical upper limit of the hardness is 10, and therefore, a hardness of 10 or less is preferable.

Furthermore, an antioxidant of, for example, a phenol type, a phosphorus type and a sulfur type may be added to the polyolefin wax of the above-described examples to prevent degradation during use at high temperature, and, a filler and a plasticizer may be added to adjust the operating temperature.

Furthermore, in another aspect, even in the case of the wax, the weight average molecular weight of less than 1,000 (Mw) causes problems concerning moldability, workability, stickiness during the handling thereafter, and the like. On the other hand,, the wax having the molecular weight exceeding 100,000 (Mw) corresponds to a resin, and therefore, is disadvantageous in the improvement of the response time which is the task of the present invention. Therefore, it is preferable that the wax and the resin are mixed to be used, in order to improve the moldability in addition to the response time in the case where the wax is used alone.

Furthermore, in the case where the operating temperature falls within the range of 50 to 180° C. and within the range of 50 to 90° C. which corresponds to a relatively low temperature region, a crystalline higher (x-olefin polymer and a hydrocarbon wax composition can be used as a polyolefin wax for the thermosensitive pellet member.

The polymerization method of the polyolefin wax of the present invention includes methods using a Ziegler catalyst and a metallocene catalyst, respectively. It is preferable to use, as a thermosensitive pellet material for the thermal fuse employing a thermosensitive pellet, a polyolefin wax by the metallocene catalyst which is known for its narrow molecular weight distribution.

It is to be noted that, in the case where a polyolefin wax selected based on the melting point is used, the region having a range of 50 to 90° C. can be covered which is otherwise difficult to be covered by the wax derived from a natural product such as a conventional paraffin wax, and therefore, the polyolefin wax achieves significant practical effects.

In the present invention, the thermoplastic resin, preferably the polyolefin resin which is the same type of the polyolefin wax is mixed with the above-described wax, to allow the moldability of the thermosensitive pellet member (10) to be improved. In this case, polyethylene, polypropylene and the like can be used as a polyolefin resin. The mixing ratio of these resins can be adjusted in the range that allows the extrusion and the injection molding for the respective waxes to be mixed.

Five types of examples will then be described in detail, in which a polyethylene wax and a polyethylene resin are mixed in different mixing ratios in the case where the above-described wax and resin are mixed. Table 5 shows mixed materials and six types of different mixing ratios. In this case, a comparative product A is a thermal fuse containing a material constituting a conventional thermosensitive pellet member, and five types of example products B-F each are a thermal fuse containing a material constituting a thermosensitive pellet member in the example of the present invention. Comparative product A using only the polyethylene resin as a thermosensitive material and five types of example products each using one of the thermosensitive materials which were different in composition ratio of the wax and the resin were prepared. These were used to prepare thermal fuses in accordance with the predetermined method as similar to the above-described example products 1-6, and each initial operating temperature thereof was measured. The results are shown in Table 6.

TABLE 5

| | Mixing Ratio (wt %) | | | | | |
|---|---|---|---|---|---|---|
| | | Exam- | Exam- | Exam- | Exam- | Exam- |
| | | ple | ple | ple | ple | ple |
| Mixed | Comparative | Product | Product | Product | Product | Product |
| Material | Product A | B | C | D | E | F |
| PE Wax | 0 | 20 | 33 | 50 | 67 | 100 |
| PE Resin | 100 | 80 | 67 | 50 | 33 | 0 |

In Table 5, “PE wax” is a polyethylene wax which has a molecular weight of 33,000 Mw and a melting point of 127° C. Furthermore, “PE resin” is a polyethylene resin which has a molecular weight of 265,000 Mw and a melting point of 129° C. In Table 5, the mixing ratio of each material is shown by wt %.

TABLE 6

| | Initial Operating Temperature (° C.) | | | | | |
|---|---|---|---|---|---|---|
| Measurement | Comparative | Example | Example | Example | Example | Example |
| No. | Product A | Product B | Product C | Product D | Product E | Product F |
| 1 | 128.9 | 128.4 | 128.2 | 128.1 | 127.7 | 127.4 |
| 2 | 128.7 | 128.3 | 128.2 | 128.0 | 127.6 | 127.3 |
| 3 | 128.5 | 128.3 | 128.0 | 127.9 | 127.5 | 127.3 |
| 4 | 128.5 | 128.2 | 128.0 | 127.8 | 127.4 | 127.2 |
| 5 | 128.4 | 128.2 | 128.0 | 127.8 | 127.4 | 127.1 |
| Average | 128.6 | 128.3 | 128.1 | 127.9 | 127.5 | 127.3 |
| Value (° C.) | | | | | | |
| Max | 128.9 | 128.4 | 128.2 | 128.1 | 127.7 | 127.4 |
| Min | 128.4 | 128.2 | 128.0 | 127.8 | 127.4 | 127.1 |
| R | 0.5 | 0.2 | 0.2 | 0.3 | 0.3 | 0.3 |

Table 6 shows the results of the five times of measurement of each initial operating temperature of the comparative product and each example product; the average values thereof, maximum values (referred to as Max in Table 6); minimum values (referred to as Min in Table 6); and variations (R=Max−Min). As seen from the results shown in Table 6, regardless of the containing ratio of the wax, the initial operating temperature falls within the range of approximately constant variations R, and the containing ratio of the wax has no effect on variations R with regard to the operating temperature of the thermal fuse. Thus, it is apparent that high operation accuracy can be ensured in each case. Furthermore, the operating temperature differs depending on the mixing ratio of the wax and the resin which are different in melting point. Accordingly, it has been found that it is efficient, as a way of finely adjusting the operating temperature, to appropriately change the mixing ratio of the wax and the resin which are different in melting point.

Furthermore, with regard to the above-described prepared five types of example products B-F and comparative product A, the response characteristics were measured. Each measurement was made under the condition that each thermal fuse was immersed in the silicone oil at the temperature of 140° C., and the time required to start the operation of the thermal fuse was measured to set a response speed. The results are shown in Table 7. Three thermal fuses were prepared for each of the example products and the comparative product, and each response speed described above was measured to compare the average values.

TABLE 7

| | Response Speed (sec.) | | | | | |
|---|---|---|---|---|---|---|
| | Comparative | Example | Example | Example | Example | Example |
| Measurement | Product A | Product B | Product C | Product D | Product E | Product F |
| 1 | 25.5 | 23.1 | 20.4 | 17.9 | 17.9 | 15.9 |
| 2 | 25.8 | 21.1 | 21.0 | 20.5 | 17.0 | 14.9 |
| 3 | 26.3 | 23.2 | 22.6 | 20.4 | 19.2 | 15.7 |
| Average | 25.9 | 22.5 | 21.3 | 19.6 | 18.0 | 15.5 |
| value (sec.) | | | | | | |
| Max | 26.3 | 23.2 | 22.6 | 20.5 | 19.2 | 15.9 |
| Min | 25.5 | 21.1 | 20.4 | 17.9 | 17.0 | 14.9 |

It has been found from the results in Table 7 that the greater the mixing ratio of the wax is, the more the response speed is increased. Furthermore, it has been confirmed that there is a difference of not less than 10 seconds on average between the response speed of example product F made of 100% of the wax and the response speed of conventional product A made of 100% of the resin.

Accordingly, it has been found from the results of the study that the thermal fuse having a thermosensitive pellet member containing an olefin wax such as a polyethylene wax allows the response speed to be increased while maintaining the operating temperature with high accuracy, as compared to the conventional thermal fuse having a thermosensitive pellet member made of resin.

According to the present invention, since the thermosensitive pellet member contains a polyolefin wax, it can be produced without any operational trouble even in the case of the member having an operating temperature set at approximately 50° C. corresponding to the low temperature region, and thus, a thermal fuse employing a thermosensitive pellet can be provided that is reliably and easily actuated at the prescribed operating temperature. Particularly, in the case where the polyolefin wax is used, the physical properties of the mechanical characteristics are well balanced and an appropriate hardness can be provided. Thus, the disadvantages of the conventional paraffin wax can be eliminated. This causes the resultant thermal fuse to be quickly actuated at the prescribed operating temperature. For example, the thermosensitive pellet member using the crystalline higher α-olefin polymer or the wax composition containing the same and a hydrocarbon wax has sharp melting characteristics as a wax having a low melting point, has an excellent balance of retentivity, hardness and the like of the mechanical characteristics, and thus, can improve the workability in the production process as a thermal fuse employing a thermosensitive pellet and the reliability in the process in which the product is used.

Furthermore, the present invention is secondarily characterized by adding a supplementary agent such as another thermoplastic resin, antioxidant, filler and the like as appropriate to the thermosensitive material containing a polyolefin wax as a main component, and, by adding such a supplementary agent, improves the physical properties of the thermosensitive pellet member. Particularly, it allows the operating temperature to be set within the range of 50 to 90° C. corresponding to the low temperature region. It is also resistant to variation in mechanical characteristics and allows the stabilized and quick actuation, that is, allows the time for actuation to be shortened. Accordingly, the thermal fuse employing a thermosensitive pellet of the present invention is of great value in practical use and improves the reliability.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A thermal fuse employing a thermosensitive pellet comprising at least a switching movable member, a thermosensitive pellet member, a pair of leads including a first lead portion and a second lead portion, and a metal casing,
said thermosensitive pellet member containing a polyolefin wax, and
said thermosensitive pellet member being housed in said metal casing to which said pair of leads are attached, and said switching movable member being operated by deformation associated with softening or melting of said thermosensitive pellet member, to attain a cut-off state between said pair of leads.

2. The thermal fuse employing a thermosensitive pellet according to claim 1, wherein said thermosensitive pellet member is made of a mixed material of said polyolefin wax and a thermoplastic resin.

3. The thermal fuse employing a thermosensitive pellet according to claim 1, wherein said thermosensitive pellet member is a member to which an antioxidant is added.

4. The thermal fuse employing a thermosensitive pellet according to claim 1, wherein
said thermosensitive pellet member has a melting temperature set within a range of an operating temperature of 50 to 180° C., and
said polyolefin wax is made of one type or two or more types of polymers selected from a group consisting of polyethylene, polypropylene and poly-α-olefin.

5. The thermal fuse employing a thermosensitive pellet according to claim 1, wherein said polyolefin wax is made of a composition of a crystalline higher α-olefin polymer and a hydrocarbon wax.

6. The thermal fuse employing a thermosensitive pellet according to claim 1, wherein said polyolefin wax is produced using a metallocene catalyst.

7. The thermal fuse employing a thermosensitive pellet according to claim 1, wherein said polyolefin wax has a weight average molecular weight of 1,000 to 100,000 (Mw) measured by a gel permeation chromatography (GPC) method.

8. The thermal fuse employing a thermosensitive pellet according to claim 6, wherein said polyolefin wax has a hardness with a rate of penetration in accordance with a measuring method defined in JIS K 2207 being not more than 10.

9. The thermal fuse employing a thermosensitive pellet according to claim 1, wherein said thermosensitive pellet member is made of a mixed material of said polyolefin wax and a polyolefin resin.

10. The thermal fuse employing a thermosensitive pellet according to claim 9, wherein said polyolefin wax and said polyolefin resin are different in melting point from each other.
